(19) United States
(12) Patent Application Publication
(10) Pub. No.: US 2023/0282849 A1
(43) Pub. Date: Sep. 7, 2023

(54) FUEL CELL SYSTEM

(71) Applicant: HONDA MOTOR CO., LTD., Tokyo (JP)

(72) Inventors: Shinya WATANABE, WAKO-SHI (JP); Tomohito KOTAKE, WAKO-SHI (JP); Eri TERADA, WAKO-SHI (JP); Kazuyuki TAKAHASHI, WAKO-SHI (JP); Masahiro MOHRI, WAKO-SHI (JP)

(21) Appl. No.: 18/114,258

(22) Filed: Feb. 26, 2023

(30) Foreign Application Priority Data
Mar. 7, 2022 (JP) 2022-034085

(51) Int. Cl. H01M 8/0444; H01M 8/04858; H01M 8/04746; H01M 8/04828; H01M 8/04007; H01M 8/04701; H01M 8/0432; H01M 8/04492; H01M 8/04119

(52) U.S. Cl. CPC H01M 8/04477; H01M 8/0494; H01M 8/04753; H01M 8/04835; H01M 8/04007; H01M 8/04723; H01M 8/04365; H01M 8/04507; H01M 8/04126; H01M 2008/1095

(57) ABSTRACT

A fuel cell system includes a cathode system device, an anode system device, an ion detector, and a controller. When the concentration of fluoride ions exceeds a predetermined concentration threshold, the controller controls at least one of the cathode system device and the anode system device to adjust a load applied to the membrane electrode assemblies.

### CROSS-REFERENCE TO RELATED APPLICATIONS

This application is based upon and claims the benefit of priority from Japanese Patent Application No. 2022-034085 filed on Mar. 7, 2022, the contents of which are incorporated herein by reference.

### BACKGROUND OF THE INVENTION

### Field of the Invention

The present invention relates to a fuel cell system.

### Description of the Related Art

In the fuel cell system, an anode gas (hydrogen gas) and a cathode gas (oxygen gas) are supplied to the fuel cell stack so that the power generation cells stacked as the fuel cell stack generate power. The power generation cells generate power by electrochemical reactions between the anode gas and the cathode gas.

The power generation cells have membrane electrode assemblies. Cross leak may occur in the membrane electrode assemblies. The cross leak is a phenomenon in which the anode gas flowing through the anode gas flow field passes through the electrolyte membrane and flows into the cathode gas flow field. This phenomenon is caused by factors such as a decrease in the thickness of the electrolyte membrane of the membrane electrode assembly or formation of minute holes in the electrolyte membrane.

JP 4547603 B2 discloses a deterioration determination device capable of determining the progress of deterioration of a fuel cell before cross leak occurs. The deterioration determination device includes a substance which is corroded by a specific component dissolved from a material constituting the membrane electrode assemblies, and determines deterioration of the fuel cells based on the progress of the corrosion of the substance.

### SUMMARY OF THE INVENTION

However, because the corrosion progresses over a relatively long period of time, there is a concern that the cross leak has already occurred when the deterioration determination device determines the corrosion of the substance. Operating the fuel cell stack in a state in which cross leak occurs may cause problems that the progress of deterioration of the membrane electrode assemblies is accelerated and the life of the membrane electrode assemblies is shortened.

An object of the present invention is to solve the aforementioned problem.

An Aspect of the present invention is to provide a fuel cell system configured to operate a fuel cell stack formed of power generation cells including membrane electrode assemblies, comprising: a cathode system device configured to supply a cathode gas to the fuel cell stack; an anode system device configured to supply an anode gas to the fuel cell stack; an ion detector disposed on a flow path through which the cathode gas or the anode gas flows and configured to detect fluoride ions dissolved from the membrane electrode assemblies; and a controller configured to control the cathode system device and the anode system device, wherein in a case where a concentration of the fluoride ions exceeds a predetermined concentration threshold, the controller controls at least one of the cathode system device or the anode system device to adjust a load applied to the membrane electrode assemblies.

According to one aspect of the present invention, it is possible to delay the progress of deterioration of the membrane electrode assemblies before cross leak occurs, and as a result, it is possible to extend the life of the membrane electrode assemblies.

The above and other objects, features and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a schematic diagram showing a configuration of a fuel cell system according to a first embodiment;

FIG. 2 is a cross-sectional view of a power generation cell;

FIG. 3 is a schematic diagram showing a configuration of a fuel cell system according to a second embodiment; and

FIG. 4 is a flowchart illustrating a flow of a control process of a controller according to the second embodiment.

### DETAILED DESCRIPTION OF THE INVENTION

### First Embodiment

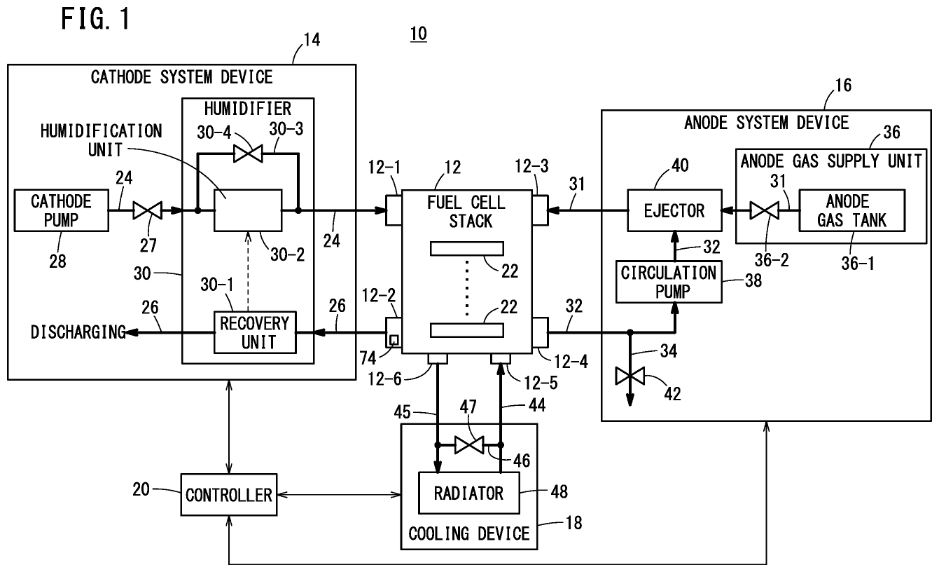

FIG. 1 is a schematic diagram showing a configuration of a fuel cell system 10 according to the first embodiment. The fuel cell system 10 is mounted on a moving object. Examples of the moving object include a vehicle, a submarine, a spacecraft, a ship, an aircraft, a robot, and the like. The vehicle may be a four wheeled vehicle (automobile) or may be a two wheeled vehicle or a three wheeled vehicle.

The fuel cell system 10 includes a fuel cell stack 12, a cathode system device 14, an anode system device 16, a cooling device 18, and a controller 20.

The fuel cell stack 12 includes a plurality of power generation cells 22. The plurality of power generation cells 22 are stacked to form a stack body. Each power generation cell 22 generates electric power by electrochemical reactions between the cathode gas and the anode gas. The cathode gas is an oxygen-containing gas containing oxygen as air, and the anode gas is a fuel gas containing hydrogen or the like.

The fuel cell stack 12 includes a cathode gas input unit 12-1 for inputting the cathode gas and a cathode gas output unit 12-2 for outputting the cathode gas. The fuel cell stack 12 includes an anode gas input unit 12-3 for inputting the anode gas, and an anode gas output unit 12-4 for outputting the anode gas. Further, the fuel cell stack 12 includes a coolant input unit 12-5 for inputting a coolant and a coolant output unit 12-6 for outputting the coolant. The coolant may be liquid or gas as long as it is a medium capable of cooling the heat generated by the fuel cell stack 12.

The cathode system device 14 supplies the cathode gas to the fuel cell stack 12. The cathode system device 14 includes a cathode supply path 24, a cathode discharge path 26, a flow control valve 27, a cathode pump 28, and a humidifier 30.

One end of the cathode supply path 24 is connected to the cathode pump 28, and the other end of the cathode supply path 24 is connected to the cathode gas input unit 12-1 of the fuel cell stack 12. The cathode gas flowing through the cathode supply path 24 is supplied to each power generation cell 22 via the cathode gas input unit 12-1.

One end of the cathode discharge path 26 is connected to the cathode gas output unit 12-2, and the other end of the cathode discharge path 26 is open to the atmosphere. The cathode gas flowing out from each power generation cell 22 is discharged to the cathode discharge path 26 via the cathode gas output unit 12-2.

The flow control valve 27 is provided on the cathode supply path 24 between the cathode pump 28 and the humidifier 30. The flow control valve 27 is configured such that an opening degree thereof can be adjusted by the controller 20. The amount of cathode gas supplied to the humidifier 30 can be adjusted in accordance with the opening degree of the flow control valve 27.

The cathode pump 28 outputs the cathode gas to the cathode supply path 24. The pressure of the cathode gas is adjustable by the cathode pump 28. The controller 20 controls the pressure of the cathode gas applied by the cathode pump 28.

The humidifier 30 humidifies the cathode gas flowing through the cathode supply path 24 with water collected from the cathode discharge path 26. The degree of humidification of the cathode gas is adjustable by the humidifier 30. The controller 20 controls the degree of humidification of the cathode gas.

For example, the humidifier 30 includes a recovery unit 30-1, a humidification unit 30-2, a bypass path 30-3, and a flow control valve 30-4. The recovery unit 30-1 is disposed on the cathode discharge path 26. The recovery unit 30-1 collects water content of the cathode gas flowing through the cathode discharge path 26 and supplies the water content to the humidification unit 30-2. The humidification unit 30-2 generates water vapor from the water content collected by the recovery unit 30-1 and supplies the generated water vapor to the cathode supply path 24. The bypass path 30-3 branches off from a portion of the cathode supply path 24 upstream of the humidification unit 30-2. The bypass path 30-3 is connected to a portion of the cathode supply path 24 downstream of the humidification unit 30-2. That is, the bypass path 30-3 is a circuit that does not pass through the humidification unit 30-2. The flow control valve 30-4 is provided on the bypass path 30-3, and is configured such that an opening degree thereof can be adjusted by the controller 20. The amount of cathode gas supplied to the humidification unit 30-2 is increased or decreased in accordance with the opening degree of the flow control valve 30-4, and thus the degree of humidification of the cathode gas can be adjusted.

The anode system device 16 supplies the anode gas to the fuel cell stack 12 and circulates the anode gas discharged from the fuel cell stack 12. The anode system device 16 includes an anode gas supply path 31, a circulation path 32, a purge path 34, an anode gas supply unit 36, a circulation pump 38, an ejector 40, and a discharge valve 42.

One end of the anode gas supply path 31 is connected to the anode gas input unit 12-3 of the fuel cell stack 12, and the other end of the anode gas supply path 31 is connected to the anode gas supply unit 36. The anode gas flowing through the anode gas supply path 31 is supplied to each power generation cell 22 via the anode gas input unit 12-3.

One end of the circulation path 32 is connected to the anode gas output unit 12-4 of the fuel cell stack 12, and the other end of the circulation path 32 is connected to the ejector 40. The anode gas flowing out from each power generation cell 22 is discharged to the circulation path 32 via the anode gas output unit 12-4. The circulation pump 38 is provided in the circulation path 32.

The purge path 34 is branched from a portion of the circulation path 32 between the anode gas output unit 12-4 and the circulation pump 38. The purge path 34 is provided with the discharge valve 42.

The anode gas supply unit 36 can supply the anode gas to the anode gas supply path 31, and the amount of the anode gas to be supplied is adjustable by the anode gas supply unit 36. The controller 20 controls the amount of the anode gas to be supplied.

For example, the anode gas supply unit 36 includes an anode gas tank 36-1 and a pressure reducing valve 36-2. The anode gas tank 36-1 stores the anode gas. The pressure reducing valve 36-2 is provided on the anode gas supply path 31 and reduces the pressure of the anode gas that has been stored in the anode gas tank 36-1. The pressure reducing valve 36-2 is configured such that the amount of reduction in the pressure of the anode gas can be adjusted by the controller 20. The amount of the anode gas flowing downstream of the pressure reducing valve 36-2 can be adjusted in accordance with the pressure reduction amount at the pressure reducing valve 36-2.

The anode gas discharged from the fuel cell stack 12 by the circulation pump 38 is supplied to the ejector 40 via the circulation path 32. The amount of the anode gas to be supplied is adjustable by the circulation pump 38. The controller 20 controls the amount of the anode gas to be supplied by the circulation pump 38.

The anode gas supplied from the anode gas supply unit 36 is supplied to the fuel cell stack 12 by the ejector 40. Further, the ejector 40 sucks the anode gas from the circulation path 32 by a negative pressure generated by the anode gas internally flowing therethrough, and supplies the anode gas to the fuel cell stack 12.

The discharge valve 42 is configured to be openable and closable. When the discharge valve 42 is open, the anode gas and water content discharged from the fuel cell stack 12 to the circulation path 32 flow to the purge path 34. On the other hand, when the discharge valve 42 is closed, the anode gas discharged from the fuel cell stack 12 to the circulation path 32 flows through the circulation pump 38. The opening and closing of the discharge valve 42 is controlled by the controller 20.

The cooling device 18 cools the coolant discharged from the fuel cell stack 12 and supplies the cooled coolant to the fuel cell stack 12. The temperature of the coolant is adjustable by the cooling device 18.

For example, the cooling device 18 includes a coolant supply path 44, a coolant discharge path 45, a coolant bypass path 46, a flow control valve 47, and a radiator 48. One end of the coolant supply path 44 is connected to the radiator 48, and the other end of the coolant supply path 44 is connected to the coolant input unit 12-5. The coolant flowing through the coolant supply path 44 is supplied between the power generation cells 22. One end of the coolant discharge path 45 is connected to the coolant output unit 12-6, and the other end of the coolant discharge path 45 is connected to the radiator 48. The coolant flowing between the power generation cells 22 flows out from the coolant output unit 12-6 to the coolant discharge path 45.

The coolant bypass path 46 is connected to the coolant discharge path 45 and the coolant supply path 44, and does not pass through the radiator 48. The flow control valve 47 is provided on the coolant bypass path 46, and is configured such that an opening degree thereof can be adjusted by the controller 20. The amount of coolant supplied to the radiator 48 is increased or decreased in accordance with the opening degree of the flow control valve 47 so that the temperature of the coolant can be adjusted.

The controller 20 comprehensively controls the entire fuel cell system 10. The controller 20 can execute a power generation operation for generating power in the fuel cell stack 12. For example, when a power generation execution command is given from an input device (not shown), the controller 20 executes a power generation operation. In this case, the controller 20 controls the cathode system device 14 to supply the cathode gas to the fuel cell stack 12, and controls the anode system device 16 to supply the anode gas to the fuel cell stack 12.

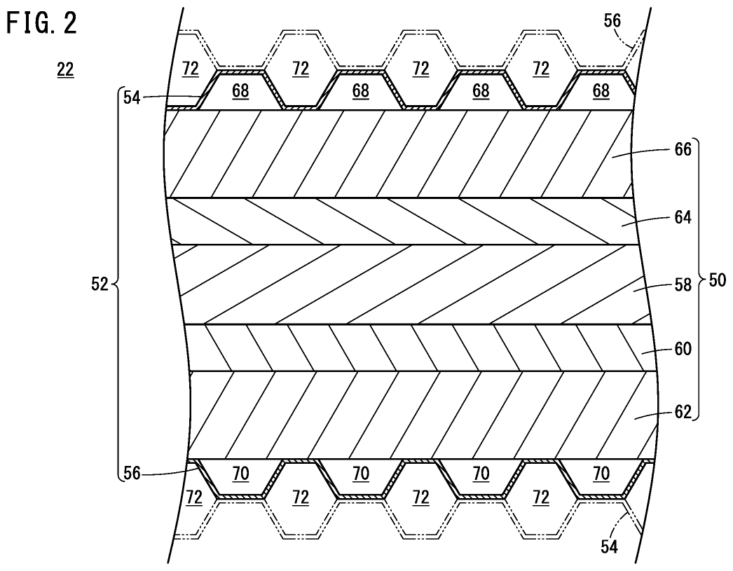

FIG. 2 is a cross-sectional view showing the power generation cell 22. The power generation cell 22 is a solid polymer electrolyte fuel cell. The power generation cell 22 includes a membrane electrode assembly 50 and separator 52. The membrane-electrode assembly 50 is hereinafter referred to as MEA 50. The separator 52 includes a first separator member 54 and a second separator member 56. The separator 52 is formed by pressing the first separator member 54 and the second separator member 56. The separator 52 sandwiches the MEA 50.

The MEA 50 includes an electrolyte membrane 58, an anode catalyst layer 60, an anode diffusion layer 62, a cathode catalyst layer 64, and a cathode diffusion layer 66. The anode catalyst layer 60 and the anode diffusion layer 62 are stacked to form an anode, and the cathode catalyst layer 64 and the cathode diffusion layer 66 are stacked to form a cathode.

The electrolyte membrane 58 is constituted by a solid polymer electrolyte membrane or the like. Specific examples thereof include fluororesin-based ion exchange membranes. The anode catalyst layer 60 is provided on one surface of the electrolyte membrane 58. The anode diffusion layer 62 is provided on a surface of the anode catalyst layer 60 opposite to the surface facing the electrolyte membrane 58. The cathode catalyst layer 64 is provided on the other surface of the electrolyte membrane 58. The cathode diffusion layer 66 is provided on a surface of the cathode catalyst layer 64 opposite to the surface facing the electrolyte membrane 58.

Grooves are formed on an inner surface of the first separator member 54 facing the cathode diffusion layer 66. These grooves form a cathode flow field 68 between the cathode diffusion layer 66 and the first separator member 54. Grooves are formed on an inner surface of the second separator member 56 facing the anode diffusion layer 62. The grooves form an anode flow field 70 between the anode diffusion layer 62 and the second separator member 56.

Grooves are formed on the outer surface of the first separator member 54 and the outer surface of the second separator member 56. The outer surface of the first separator member 54 is a surface opposite to the inner surface of the first separator member 54, and the outer surface of the second separator member 56 is a surface opposite to the inner surface of the second separator member 56.

When another power generation cell 22 is arranged adjacent to the first separator member 54, the grooves formed on the outer surface of the first separator member 54 and the grooves formed on the outer surface of the second separator member 56 of the other power generation cell 22 constitute a coolant flow field 72. Similarly, when another power generation cell 22 is arranged adjacent to the second separator member 56, the grooves formed on the outer surface of the second separator member 56 and the grooves formed on the outer surface of the first separator member 54 of the other power generation cell 22 constitute the coolant flow field 72.

The fuel cell system 10 of the present embodiment further includes an ion detector 74 (FIG. 1). The ion detector 74 detects fluoride ions dissolved from the MEA 50 and outputs a detection signal to the controller 20.

The fluoride ions come from the MEA 50 move to the cathode flow field 68 or the anode flow field 70 and dissolves in the water contained in the anode gas or the cathode gas. The ion detector 74 is provided on a flow path through which the anode gas or the cathode gas flows. FIG. 1 shows an example in which the ion detector 74 is provided in the cathode gas output unit 12-2 of the fuel cell stack 12.

During the power generation operation of the fuel cell stack 12, the controller 20 measures the concentration of fluoride ions based on the detection signal detected by the ion detector 74. Fluoride ions are dissolved from the MEA 50 before cross leakage occurs. Therefore, the controller 20 can sensitively capture the progress of the deterioration of the MEA 50 before the occurrence of the cross leak.

The controller 20 compares the concentration of fluoride ions with a predetermined concentration threshold. When the concentration of fluoride ions exceeds the predetermined concentration threshold, the controller 20 controls at least one of the cathode system device 14 and the anode system device 16 to adjust the load applied to the membrane electrode assemblies of the power generation cells 22. As a result, the progress of the deterioration of the MEA 50 can be delayed before the cross leak occurs.

The controller 20 may reduce the load applied to the MEA 50 as the concentration of the fluoride ions increases. Thus, the extent to which the progress of the deterioration of the MEA 50 is delayed can be adjusted in accordance with the concentration of the fluoride ions.

The controller 20 can select at least one of the plurality of control processes in order to reduce the load applied to the MEA 50.

That is, the controller 20 can reduce the flow rate of the cathode gas by controlling the cathode system device 14. In the present embodiment, the controller 20 controls the flow control valve 27 of the cathode system device 14 such that the opening degree of the flow control valve 27 decreases as the concentration of fluoride ions increases. As a result, oxygen is inhibited from permeating from the cathode side to the anode side of the MEA 50. As a result, deterioration of the MEA 50 can be suppressed.

Further, the controller 20 may control the cathode system device 14 to reduce the pressure of the cathode gas. In the present embodiment, the controller 20 controls the cathode pump 28 to reduce the pump pressure as the concentration of fluoride ions increases. As a result, the pressure of the cathode gas decreases. As a result, oxygen is inhibited from permeating from the cathode side to the anode side of the MEA 50. As a result, deterioration of the MEA 50 can be suppressed.

When decreasing the pressure of the cathode gas, the controller 20 may control the anode system device 16 to decrease the pressure of the anode gas. In the present embodiment, for example, the controller 20 controls the pressure reducing valve 36-2 so that the difference between the pressure of the cathode gas and the pressure of the anode gas becomes constant. As a result, it is possible to prevent the differential pressure between the anode side and the cathode side of the MEA 50 from becoming excessively wide.

Further, the controller 20 can increase the degree of humidification of the cathode gas by controlling the humidifier 30. In the present embodiment, as the concentration of the fluoride ions increases, the controller 20 decreases the opening degree of the flow control valve 30-4 and increases the amount of the cathode gas to be supplied to the humidification unit 30-2. Thereby, the anti-radical properties in the MEA 50 can be enhanced. As a result, deterioration of the MEA 50 can be suppressed.

In addition, the controller 20 may control the cooling device 18 to decrease the temperature of the coolant. In the present embodiment, as the concentration of fluoride ions increases, the controller 20 decreases the opening degree of the flow control valve 47 and increases the amount of the coolant to be cooled by the radiator 48. As a result, the temperature of the coolant decreases, and the ability of the coolant for cooling the fuel cell stack 12 is increased. Thus, the reaction rate of the electrochemical reaction in the power generation cell 22 can be suppressed. As a result, deterioration of the MEA 50 can be suppressed.

### Second Embodiment

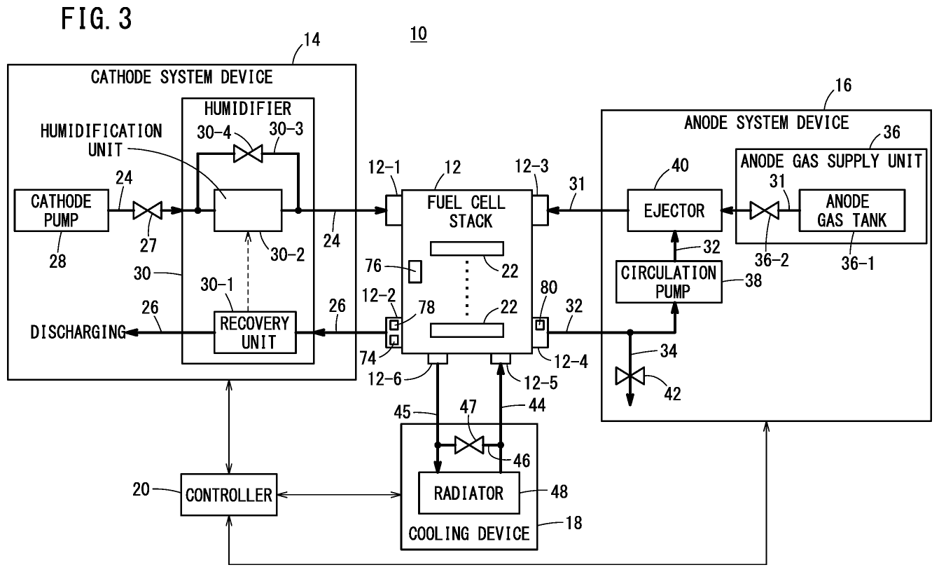

FIG. 3 is a diagram showing a fuel cell system 10 according to a second embodiment. In FIG. 3, the same components as those described in the first embodiment are denoted by the same reference numerals. In the present embodiment, descriptions that have been made in the first embodiment is omitted.

The fuel cell system 10 of the present embodiment further includes a temperature sensor 76, a first humidity sensor 78, and a second humidity sensor 80.

The temperature sensor 76 detects the temperature of the fuel cell stack 12 and outputs a detection signal to the controller 20. The temperature sensor 76 may be provided outside the fuel cell stack 12 or inside the fuel cell stack 12.

The first humidity sensor 78 detects the humidity (relative humidity) of the cathode gas and outputs a detection signal to the controller 20. The first humidity sensor 78 is provided on the flow path of the cathode gas. FIG. 3 shows an example in which the first humidity sensor 78 is provided in the cathode gas output unit 12-2 of the fuel cell stack 12.

The second humidity sensor 80 detects the humidity (relative humidity) of the anode gas and outputs a detection signal to the controller 20. The second humidity sensor 80 is provided on the flow path of the anode gas. FIG. 3 shows an example in which the second humidity sensor 80 is provided in the anode gas output unit 12-4 of the fuel cell stack 12.

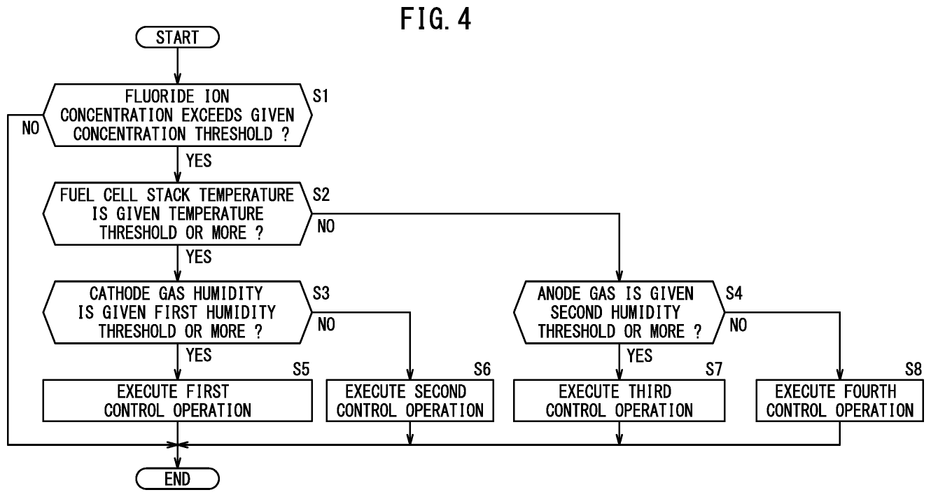

FIG. 4 is a flowchart illustrating a flow of control processing of the controller 20 according to the second embodiment. The control processing of the controller 20 is executed at predetermined intervals. The controller 20 measures the concentration of fluoride ions based on the detection signal output from the ion detector 74, and compares the concentration of fluoride ions with a predetermined concentration threshold (step S1).

When the concentration of fluoride ions exceeds the predetermined concentration threshold (step S1: YES), the controller 20 executes any one of the first control operation, the second control operation, the third control operation, and the fourth control operation based on the detection signals output from the temperature sensor 76, the first humidity sensor 78, and the second humidity sensor 80.

That is, when the temperature of the fuel cell stack 12 detected by the temperature sensor 76 is equal to or higher than the predetermined temperature threshold (step S2: YES) and the humidity of the cathode gas detected by the first humidity sensor 78 is equal to or higher than the predetermined first humidity threshold (step S3: YES), the controller 20 executes the first control operation (step S5). In this case, the controller 20 controls the cooling device 18 to decrease the temperature of the coolant, and controls the cathode system device 14 to increase the pressure of the cathode gas. Accordingly, the amount of water contained in the anode gas and the cathode gas can be increased, and the fluoride ion concentration can be decreased by the increased water. When the controller 20 controls the cathode system device 14 to increase the pressure of the cathode gas, the controller 20 may control the anode system device 16 to increase the pressure of the anode gas so that the difference between the pressure of the cathode gas and the pressure of the anode gas becomes constant.

When the temperature of the fuel cell stack 12 detected by the temperature sensor 76 is equal to or higher than the predetermined temperature threshold (step S2: YES) and the humidity of the cathode gas detected by the first humidity sensor 78 is lower than the predetermined first humidity threshold (step S3: NO), the controller 20 executes the second control operation (step S6). In this case, the controller 20 controls the cooling device 18 to decrease the temperature of the coolant, and controls the cathode system device 14 to increase the degree of humidification of the cathode gas. In addition, the controller 20 controls the cathode system device 14 to decrease the flow rate of the cathode gas and decrease the pressure of the cathode gas. As a result, the water contents of the anode gas and the cathode gas can be increased, and the fluoride ion concentration can be decreased by the increase in the water contents. When the controller 20 controls the cathode system device 14 to decrease the pressure of the cathode gas, the controller 20 may control the anode system device 16 to decrease the pressure of the anode gas so that the difference between the pressure of the cathode gas and the pressure of the anode gas becomes constant.

When the temperature of the fuel cell stack 12 detected by the temperature sensor 76 is lower than the predetermined temperature threshold (step S2: NO) and the humidity of the anode gas detected by the second humidity sensor 80 is equal to or higher than the predetermined second humidity threshold (step S4: YES), the controller 20 executes the third control operation (step S7). In this case, the controller 20 controls the cathode system device 14 to reduce the pressure of the cathode gas. As a result, the water contents of the anode gas and the cathode gas can be increased, and the fluoride ion concentration can be decreased by the increase in the water contents. When the controller 20 controls the cathode system device 14 to decrease the gas pressure of the cathode gas, the controller 20 may control the anode system device 16 to decrease the pressure of the anode gas so that the difference between the pressure of the cathode gas and the pressure of the anode gas becomes constant.

When the temperature of the fuel cell stack 12 detected by the temperature sensor 76 is lower than the predetermined temperature threshold (step S2: NO) and the humidity of the anode gas detected by the second humidity sensor 80 is lower than the predetermined second humidity threshold (step S4: NO), the controller 20 executes the fourth control operation (step S8). In this case, the controller 20 controls the cathode system device 14 to increase the degree of humidification of the cathode gas. In addition, the controller 20 controls the cathode system device 14 to decrease the flow rate of the cathode gas and decrease the pressure of the cathode gas. As a result, with suppression of vaporization of water contained in the anode gas and the cathode gas, the water contents of the anode gas and the cathode gas in the MEA 50 can be increased to reduce the fluoride ion concentration. When the controller 20 controls the cathode system device 14 to decrease the pressure of the cathode gas, the controller 20 may control the anode system device 16 to decrease the pressure of the anode gas so that the difference between the pressure of the cathode gas and the pressure of the anode gas becomes constant.

As described above, when the concentration of fluoride ions exceeds the predetermined concentration threshold, the controller 20 controls at least one of the cathode system device 14 and the anode system device 16 based on the temperature of the fuel cell stack 12, the humidity of the anode gas, and the humidity of the cathode gas. This makes it possible to improve the stability of power generation in the power generation cells 22 as compared with the case where the stack temperature and the gas humidity are not taken into consideration.

A description will be given below concerning technical concepts and effects that are capable of being grasped from the above descriptions.

An Aspect of the present invention is to provide the fuel cell system (10) configured to operate the fuel cell stack (12) accommodating power generation cells (22) including membrane electrode assemblies (50), comprising: the cathode system device (14) configured to supply the cathode gas to the fuel cell stack; the anode system device (16) configured to supply the anode gas to the fuel cell stack; the ion detector (74) disposed on a flow path through which the cathode gas or the anode gas flows and configured to detect fluoride ions dissolved from the membrane electrode assemblies; and the controller (20) configured to control the cathode system device and the anode system device, wherein in the case where the concentration of the fluoride ions exceeds the predetermined concentration threshold, the controller controls at least one of the cathode system device or the anode system device to adjust a load applied to the membrane electrode assemblies.

In this way, it is possible to delay the progress of deterioration of the membrane electrode assemblies before cross leak occurs, and as a result, it is possible to extend the life of the membrane electrode assemblies.

The controller may reduce the load applied to the membrane electrode assemblies as the concentration of the fluoride ions increases. Thus, the extent to which the progress of the deterioration of the membrane electrode assemblies is delayed can be adjusted in accordance with the concentration of the fluoride ions.

That is, the controller can reduce the flow rate of the cathode gas by controlling the cathode system device. As a result, oxygen is inhibited from permeating from the cathode side to the anode side of the membrane electrode assemblies. As a result, deterioration of the membrane electrode assemblies can be suppressed.

The controller may control the cathode system device to reduce the pressure of the cathode gas. As a result, oxygen is inhibited from permeating from the cathode side to the anode side of the membrane electrode assemblies. As a result, deterioration of the membrane electrode assemblies can be suppressed.

The controller may control the anode system device to reduce the pressure of the anode gas. As a result, it is possible to prevent the differential pressure between the anode side and the cathode side of the membrane electrode assemblies from becoming excessively wide.

The cathode system device may include the humidifier (30) configured to humidify the cathode gas, and the controller may control the humidifier to increase a degree of humidification of the cathode gas. Thereby, the anti-radical properties in the membrane electrode assemblies can be enhanced. As a result, deterioration of the membrane electrode assemblies can be suppressed.

The fuel cell system may further include the cooling device (18) configured to cool the coolant supplied from the fuel cell stack and supplies the cooled coolant to the fuel cell stack, and the controller may control the cooling device to lower the temperature of the coolant. Thus, the reaction rate of the electrochemical reaction in the power generation cells can be suppressed. As a result, deterioration of the membrane electrode assemblies can be suppressed.

The fuel cell system may further include: the temperature sensor (76) provided with respect to the fuel cell stack and configured to detect a temperature of the fuel cell stack; the first humidity sensor (78) provided on the flow path through which the cathode gas flows and configured to detect the humidity of the cathode gas; and the second humidity sensor (80) provided on the flow path through which the anode gas flows and configured to detect the humidity of the anode gas, wherein in the case where the fluoride ion concentration exceeds the concentration threshold, the controller may control at least one of the cathode system device and the anode system device based on the temperature sensor, the first humidity sensor, and the second humidity sensor. This makes it possible to improve the stability of power generation in the power generation cells as compared with the case where the stack temperature and the gas humidity are not taken into consideration.

The present invention is not limited to the above disclosure, and various modifications are possible without departing from the essence and gist of the present invention.

1. A fuel cell system configured to operate a fuel cell stack accommodating power generation cells including membrane electrode assemblies, comprising:
a cathode system device configured to supply a cathode gas to the fuel cell stack;
an anode system device configured to supply an anode gas to the fuel cell stack;
an ion detector disposed on a flow path through which the cathode gas or the anode gas flows and configured to detect fluoride ions dissolved from the membrane electrode assemblies; and
a controller configured to control the cathode system device and the anode system device,
wherein in a case where a concentration of the fluoride ions exceeds a predetermined concentration threshold, the controller controls at least one of the cathode system device or the anode system device to adjust a load applied to the membrane electrode assemblies.

2. The fuel cell system according to claim 1, wherein the controller reduces the load applied to the membrane electrode assemblies as the concentration of the fluoride ions increases.

3. The fuel cell system according to claim 1, wherein the controller controls the cathode system device to reduce a flow rate of the cathode gas.

4. The fuel cell system according to claim 1, wherein the controller controls the cathode system device to reduce a pressure of the cathode gas.

5. The fuel cell system according to claim 4, wherein the controller controls the anode system device to reduce a pressure of the anode gas.

6. The fuel cell system according to claim 1, wherein the cathode system device includes a humidifier configured to humidify the cathode gas, and
the controller controls the humidifier to increase a degree of humidification of the cathode gas.

7. The fuel cell system according to claim 1, further comprising
a cooling device configured to cool a coolant supplied from the fuel cell stack and supply a cooled coolant to the fuel cell stack,
wherein the controller controls the cooling device to lower a temperature of the coolant.

8. The fuel cell system according to claim 1, further comprising:
a temperature sensor provided in the fuel cell stack and configured to detect a temperature of the fuel cell stack;
a first humidity sensor provided on a flow path through which the cathode gas flows and configured to detect humidity of the cathode gas; and
a second humidity sensor provided on a flow path through which the anode gas flows and configured to detect humidity of the anode gas,
wherein in a case where the concentration of the fluoride ions exceeds the concentration threshold, the controller controls at least one of the cathode system device and the anode system device based on the temperature sensor, the first humidity sensor, and the second humidity sensor.
